(19) United States
(12) Patent Application Publication
(10) Pub. No.: US 2026/0196145 A1
(43) Pub. Date: Jul. 9, 2026

(54) VIRTUAL REALITY COMMUNICATION SYSTEM INCLUDING ERROR PREVENTION FUNCTION BASED ON ARTIFICIAL INTELLIGENCE LANGUAGE MODEL

(71) Applicant: IUCF-HYU (Industry-University Cooperation Foundation Hanyang University), Seoul (KR)

(72) Inventors: Ji-Young YEO, Seoul (KR); Soomin LEE, Seoul (KR)

(73) Assignee: IUCF-HYU (Industry-University Cooperation Foundation Hanyang University), Seoul (KR)

(21) Appl. No.: 19/557,595

(22) Filed: Mar. 5, 2026

Related U.S. Application Data
(63) Continuation of application No. PCT/KR2024/000254, filed on Jan. 5, 2024.

(30) Foreign Application Priority Data
Sep. 5, 2023 (KR) 10-2023-0117647
Jan. 5, 2024 (KR) 10-2024-0002000

(51) Int. Cl. G09B 9/00; G06F 40/289; G06F 40/35; G06F 40/40; G10L 13/02

(52) U.S. Cl. CPC G09B 9/00; G06F 40/289; G06F 40/35; G06F 40/40; G10L 13/02

(57) ABSTRACT

A virtual reality communication method including an artificial intelligence language model-based error prevention function proposed herein includes providing, to a user through a virtual reality (VR) device, a virtual hospital environment for virtual reality-based Situation, Background, Assessment, Recommendation (SBAR) communication training for nurses, and receiving speech from the user as input; converting the input speech to text through a speech-to-text converter; recognizing SBAR from the converted text, and extracting patient-and-situation-related data through a data extractor; merging the extracted patient-and-situation-related data with prestored previous dialogue analysis data through a data merger; analyzing the merged data to identify missing information and to generate a scenario-based doctor response dialogue as text through a dialogue generator; requesting speech conversion for the generated doctor response dialogue text through the speech-to-text converter and extracting the converted speech; and playing the doctor response dialogue as speech for the user through the VR device.

### CROSS-REFERENCE TO RELATED APPLICATIONS

This U.S. non-provisional application is a continuation application of PCT International Application PCT/KR 2024/000254, which has an international filing date of Jan. 5, 2024, and claims priorities under 35 U.S.C. 119 to Korean Patent Application No. 10-2023-0117647, filed on Sep. 5, 2023 and Korean Patent Application No. 10-2024-0002000, filed on Jan. 5, 2024, in the Korean intellectual property office, the disclosures of which are herein incorporated by reference in its entirety.

### BACKGROUND

### 1. Field of the Invention

The present invention relates to a virtual reality communication method and system including an artificial intelligence language model-based error prevention function, and more particularly, to a method and system for virtual reality-based Situation, Background, Assessment, Recommendation (SBAR) communication training for nurses.

2. Description of the Related Art

The domestic and overseas software (SW) industry is experiencing steady growth in sales and employment. However, the SW industry's technical workforce shortage rate is currently at 4.3%, exacerbating the labor shortage. The supply of human resources is limited compared to the explosive increase in demand for human resources.

Also, the demand for work cooperation tools is increasing due to various factors, such as non-face-to-face work and digital conversion, and a plurality of cooperation tools, such as Slack and Notion, are being introduced. In addition, traditional work environments are disappearing, the need for new form of cooperation is increasing, and there are increasing cases of close cooperative relationships not only with internal members of organization but also with external parties.

The SW development imposes a significant burden on acquiring work-related knowledge, and the iterative complex communication process makes it difficult to maintain the work efficiency and productivity. Also, the development task is not completed for a shorter period of time although additional personnel are added, and it takes a time for newly added personnel to begin productive work.

These issues occur not only in the software development task but also other various tasks, and there is a need for research on a solution to more efficiently perform tasks.

### SUMMARY

A technical subject to be achieved by the present invention is to provide a virtual reality communication method and system including an artificial intelligence language model-based error prevention function to help effective communication training between medical staff as Situation, Background, Assessment, Recommendation (SBAR) communication training to improve nurses'communication skills. An example embodiment is to automate a virtual reality communication system by replacing the virtual reality communication system with an artificial intelligence language model-based software program.

According to an aspect, there is provided a virtual reality communication method including providing, to a user through a virtual reality (VR) device, a virtual hospital environment for virtual reality-based Situation, Background, Assessment, Recommendation (SBAR) communication training for nurses, and receiving speech from the user as input; converting the input speech to text through a speech-to-text converter; recognizing SBAR from the converted text, and extracting patient-and-situation-related data through a data extractor; merging the extracted patient-and-situation-related data with prestored previous dialogue analysis data through a data merger; analyzing the merged data to identify missing information and to generate a scenario-based doctor response dialogue as text through a dialogue generator; requesting speech conversion for the generated doctor response dialogue text through the speech-to-text converter and extracting the converted speech; and playing the doctor response dialogue as speech for the user through the VR device.

The recognizing the SBAR from the converted text and the extracting the patient-and-situation-related data through the data extractor may include extracting and classifying intent of user speech and information included in the text using the converted text that is input from the speech-to-text converter and prestored previous context information.

The recognizing the SBAR from the converted text and the extracting the patient-and-situation-related data through the data extractor may include receiving an identification number of the VR device and scenario information from the speech-to-text converter as input, and performing training according to a corresponding scenario based on an interactive artificial intelligence language model.

The merging the extracted patient-and-situation-related data with the prestored previous dialogue analysis data through the data merger may include classifying and datafying slot information and intent information of user speech related to the patient-and-situation-related data extracted from the text according to a predetermined format, and merging and storing the same with prestored previous dialogue analysis data that is extracted from the user speech.

The analyzing the merged data to identify missing information and to generate the scenario-based doctor response dialogue as text through the dialogue generator may include comparing data accumulated from a start point in time of virtual reality communication and patient-and-situation-related data required for a scenario, and analyzing slot information required at a current point in time among the missing information to generate text for requesting from the user.

The analyzing the merged data to identify missing information and to generate the scenario-based doctor response dialogue as text through the dialogue generator may include, in order to input scenario information to a pretrained interactive artificial intelligence language model and to request a situational drama from the user, generating a doctor response dialogue for delivering the patient-and-situation-related data required for the scenario as text, and analyzing a user input phrase that is input in real time in response to the request through the interactive artificial intelligence language model.

The analyzing the merged data to identify missing information and to generate the scenario-based doctor response dialogue as text through the dialogue generator may include fetching prestored previous dialogue analysis data from the data merger in order to generate the scenario-based doctor response dialogue as text, using the previous dialogue analysis data and patient-and-situation-related data extracted from text that is received as current input through a pretrained interactive artificial intelligence language model, and repeatedly generating a scenario-based doctor response dialogue according to the analysis results in order to reset a situational drama when an error occurs in the situational drama based on the scenario.

According to another aspect, there is provided a virtual reality communication system including a virtual reality (VR) device configured to provide, to a user, a virtual hospital environment for virtual reality-based Situation, Background, Assessment, Recommendation (SBAR) communication training for nurses, to receive speech from the user as input, and to play speech for doctor response dialogue text converted by a speech-to-text converter for the user; the speech-to-text converter configured to convert the input speech to text, to request speech conversion for the doctor response dialogue text generated by a dialogue generator, and to extract the converted speech; a data extractor configured to recognize SBAR from the converted text and to extract patient-and-situation-related data; a data merger configured to merge the extracted patient-and-situation-related data with prestored previous dialogue analysis data; and the dialogue generator configured to analyze the merged data to identify missing information and to generate a scenario-based doctor response dialogue as text.

Through a virtual reality communication system including an artificial intelligence language model-based error prevention function according to example embodiments, SBAR communication training for improving nurses'communication skills may be performed without restrictions on a time and an occasion in a non-face-to-face manner. According to an example embodiment, it is to automate a virtual reality communication system by replacing the same with a software program based on an artificial intelligence language model, so this approach may present an alternative to traditional training methods due to its high accessibility and convenience, high learning accuracy, and consistent personalized training compared to traditional face-to-face training methods.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating a virtual reality communication method including an artificial intelligence language model-based error prevention function according to an example embodiment;

FIG. 2 is a diagram illustrating a configuration of a virtual reality communication system including an artificial intelligence language model-based error prevention function according to an example embodiment;

FIGS. 3A and 3B illustrates an example of scenario information input from a speech-to-text converter according to an example embodiment;

FIGS. 4A TO 4C illustrates a process of classifying and datafying slot information and intent information extracted from user speech text based on a scenario according to an example embodiment;

FIGS. 5A and 5B illustrates a process of performing training based on a scenario according to an example embodiment;

FIGS. 6A TO 6C illustrates a process of extracting scenario information according to an example embodiment;

FIGS. 7A TO 7C illustrates a process of classifying information required for a Situation, Background, Assessment, Recommendation (SBAR) situation within analysis results according to an example embodiment; and

FIGS. 8A and 8B illustrates response data of a server according to an example embodiment.

### DETAILED DESCRIPTION

As the need for Situation, Background, Assessment, Recommendation (SBAR) communication training to improve nurses'communication skills has been raised, interpersonal communication practice has been conducted. The present invention is to automate the communication training by replacing this with an artificial intelligence language model-based software program, and may present an alternative to traditional training methods due to its high accessibility and convenience, high learning accuracy, and consistent personalized training compared to traditional face-to-face training methods.

The present invention proposes a system for virtual reality-based Situation, Background, Assessment, Recommendation (SBAR) communication training for nurses, and utilizes an interactive artificial intelligence language model (e.g., ChatGPT) for this purpose. According to an example embodiment, a trainee wears virtual reality (VR) goggles and practices communication between medical staff through dialogue-based role playing with ChatGPT in a virtual hospital environment. GPT's responses are classified and verified using a large language model (LLM). If an error occurs in the response, training continues by readjusting ChatGPT's role settings. Although ChatGPT is described as an example in the example embodiment, it is only an example and various other interactive artificial intelligence language models may be used.

For a nursing student to proceed with SBAR communication training through a virtual reality communication method and system including an artificial intelligence language model-based error prevention function according to an example embodiment, SBAR-related information may be extracted from input sentences that are coming in as real-time speech, required patient information that has not yet been received may be recognized from the extracted information, and a sentence that guides the student to speak the information later may be output as a response.

However, recognizing only information of a specific domain from a real-time natural language input sentence and using the results to generate a dialogue to elicit information from the other party that is required for learning but has not yet been input is a truly difficult problem.

Also, technology for analyzing the configuration of information in a sentence that simply lists information on a specific patient and a current nursing situation in a medical situation, rather than a sentence that requests or asks information for the specific purpose, and then generating a question about missing information based on the analyzed configuration is not disclosed.

According to an example embodiment, proposed is a virtual reality communication method and system including an artificial intelligence language model-based error prevention function that generates a counter-question for a natural sentence rather than a simple response to a query. Hereinafter, example embodiments are described in detail with reference to the accompanying drawings.

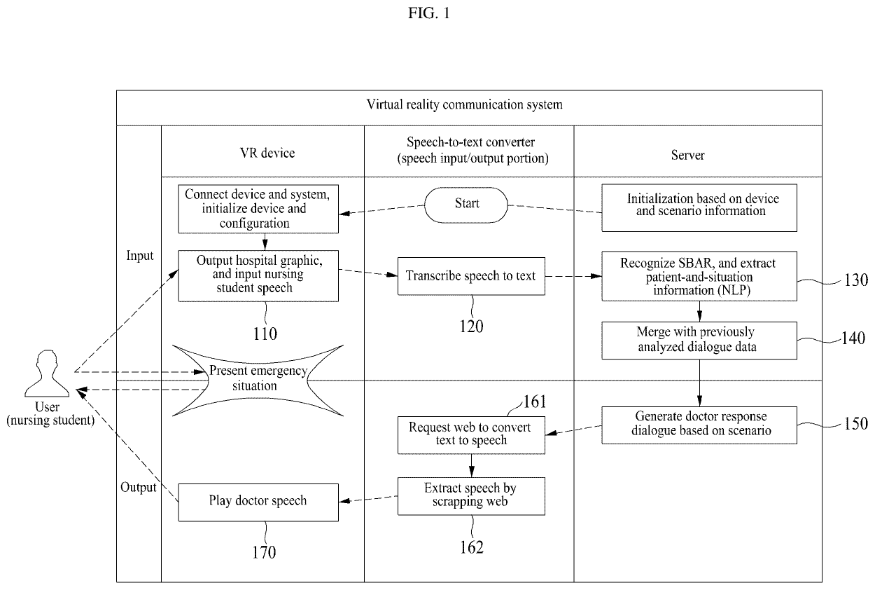

FIG. 1 is a flowchart illustrating a virtual reality communication method including an artificial intelligence language model-based error prevention function according to an example embodiment.

Through the virtual reality communication method including the artificial intelligence language model-based error prevention function according to an example embodiment, an artificial intelligence-based speech dialogue system is constructed in a virtual reality (VR) environment to practice nursing education requiring a counterpart role in a virtual environment without the help from others. To construct the VR environment according to an example embodiment, the Unity program is connected to a natural language processing application program interface (API) server, and a program produced with Unity is linked to a VR device. The Unity program according to an example embodiment is described as a speech-to-text converter.

The virtual reality communication method including the artificial intelligence language model-based error prevention function according to an example embodiment may include providing, to a user through a VR device, a virtual hospital environment for virtual reality-based Situation, Background, Assessment, Recommendation (SBAR) communication training for nurses, and receiving speech from the user as input (110); converting (that is, transcribing) the input speech to text through a speech-to-text converter (120); recognizing SBAR from the converted text, and extracting patient-and-situation-related data through a data extractor (130); merging the extracted patient-and-situation-related data with prestored previous dialogue analysis data through a data merger (140); analyzing the merged data to identify missing information and to generate a scenario-based doctor response dialogue as text through a dialogue generator (150); requesting speech conversion for the generated doctor response dialogue text through the speech-to-text converter (161) and extracting the converted speech (162); and playing the doctor response dialogue as speech for the user through the VR device (170).

According to an example embodiment, input and interruption of user (e.g., nursing student) speech through the VR device is detected by the Unity program (i.e., speech-to-text converter), the VR device and the virtual reality communication system are connected, and the VR device, the virtual reality communication system, and scenario information are initialized.

In operation 110, the virtual hospital environment for virtual reality-based SBAR communication training for nurses is provided to the user (e.g., nursing student) through the VR device, and speech is input from the user.

In operation 120, the input speech is converted to the text through the speech-to-text converter.

The speech-to-text converter according to an example embodiment waits for whether subsequent input is absent for, for example, 2 seconds from a point in time at which the detected user speech is stopped and then, transmits the converted text for the detected user speech to a server.

In operation 130, SBAR is recognized from the converted text, and the patient-and-situation-related data is extracted through the data extractor.

The purpose is to receive the converted text and prestored previous context information, and to appropriately extract and classify the intent of the user speech and information included in the corresponding text through the data extractor of the server according to an example embodiment,

According to an example embodiment, a model additionally trained to fit a nursing scenario based on an interactive artificial intelligence language model (e.g., ChatGPT) is used. Since which part of the text to focus on to extract information differs depending on the nursing scenario, an identification number of the VR device and usage scenario information may be input from the speech-to-text converter according to an example embodiment, and a model trained to fit the scenario may be selected and used.

In operation 140, the extracted patient-and-situation-related data is merged with the prestored previous dialogue analysis data through the data merger.

According to an example embodiment, the slot information and the intent information extracted from the user speech text are classified and datafied according to a predetermined format based on a scenario, and stored in addition to data extracted from previous user speech and recorded in the virtual reality communication system.

In operation 150, the scenario-based doctor response dialogue is generated as text through the dialogue generator.

The server according to an example embodiment compares data accumulated from a start point in time of the virtual reality communication system and patient-and-situation information required for the scenario, and generates doctor response dialogue text that requests slot information most required at a current point in time among missing information from the user.

According to an example embodiment, in order to input scenario information to the pretrained interactive artificial intelligence language model and to request a situational drama from the user, a doctor response dialogue for delivering the patient-and-situation-related data required for the scenario as text is generated, and a user input phrase that is input in real time in response to the request is analyzed through the interactive artificial intelligence language model.

Prestored previous dialogue analysis data is fetched from the data merger in order to generate the scenario-based doctor response dialogue as text, the previous dialogue analysis data and patient-and-situation-related data extracted from text that is received as current input are used through the pretrained interactive artificial intelligence language model, and a scenario-based doctor response dialogue according to the analysis results is repeatedly generated in order to rest the situational drama when an error occurs in the situational drama based on the scenario.

When the server transmits the generated text to the speech-to-text converter as a response, the speech-to-text converter requests a webpage to convert the text to speech (161), and extracts speech by scrapping the conversion results (162).

In operation 170, the doctor response dialogue is played as speech for the user through the VR device.

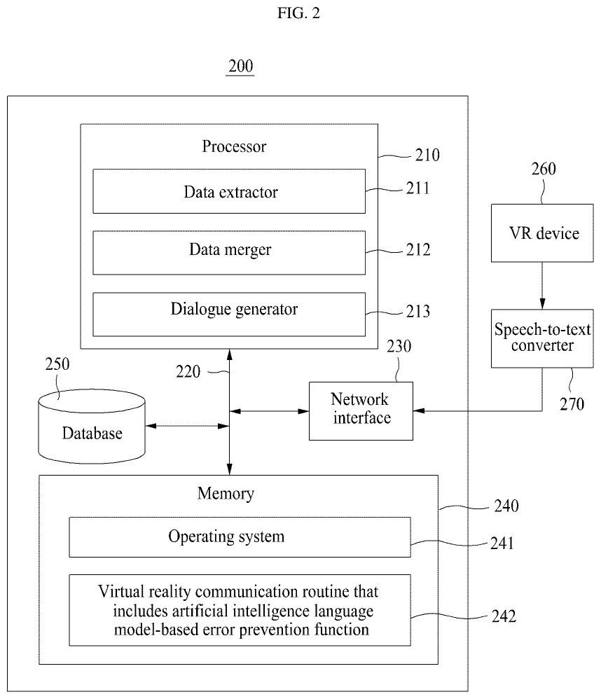

FIG. 2 is a diagram illustrating a configuration of a virtual reality communication system that includes an artificial intelligence language model-based error prevention function according to an example embodiment.

A virtual reality communication system 200 according to the example embodiment may include a processor 210, a bus 220, a network interface 230, a memory 240, and a database 250. The memory 240 may include an operating system 241 and a virtual reality communication routine 242 that includes an artificial intelligence language model-based error prevention function. The processor 210 may include a data extractor 211, a data merger 212, a dialogue generator 213, a VR device 260, and a speech-to-text converter 270. In other example embodiments, the virtual reality communication system 200 may include a greater number of components than the components of FIG. 2. However, there is no need to clearly illustrate many conventional components. For example, the virtual reality communication system 200 may include other components, such as a display or a transceiver.

The memory 240 may include a permanent mass storage device, such as a random access memory (RAM), a read only memory (ROM), and a disk drive as a computer-readable recording medium. Also, the memory 240 may store a program code for the operating system 241 and the virtual reality communication routine 242 that includes the artificial intelligence language model-based error prevention function. Such software components may be loaded from a computer-readable recording medium separate from the memory 240 using a drive mechanism (not shown). The separate computer-readable recording medium may include a computer-readable recording medium (not shown), such as a floppy drive, a disc, a tape, a DVD/CD-ROM drive, and a memory card. In other example embodiments, the software components may be loaded to the memory 240 through the network interface 230 instead of the computer-readable recording medium.

The bus 220 enables communication and data transmission between the components of the virtual reality communication system 200. The bus 220 may be constructed using a high-speed serial bus, a parallel bus, a Storage Area Network (SAN) and/or another appropriate communication technology.

The network interface 230 may be a computer hardware component for connecting the virtual reality communication system 200 to a computer network. The network interface 230 may connect the virtual reality communication system 200 to the computer network through wireless or wired connection.

The database 250 may serve to store and maintain all information required for virtual reality communication that includes the artificial intelligence language model-based error prevention function. Although FIG. 2 illustrates that the database 250 is constructed and included in the virtual reality communication system 200, it is only an example. Without being limited thereto, the database 250 may be omitted depending on a system implementation method or environment. Alternatively, all or a portion of the database 250 may be present as an external database constructed on a separate system.

The processor 210 may be configured to process instructions of a computer program by performing basic arithmetic operations, logical operations, and input/output operations of the virtual reality communication system 200. The instruction may be provided to the processor 210 by the memory 240 or the network interface 230, and through the bus 220. The processor 210 may be configured to execute a program code for the data extractor 211, the data merger 212, the dialogue generator 213, the VR device 260, and the speech-to-text converter 270. This program code may be stored in a storage device, such as the memory 240.

The data extractor 211, the data merger 212, the dialogue generator 213, the VR device 260, and the speech-to-text converter 270 may be configured to perform operations 110 to 170 of FIG. 1.

The virtual reality communication system 200 may include the data extractor 211, the data merger 212, the dialogue generator 213, the VR device 260, and the speech-to-text converter 270.

The VR device 260 according to an example embodiment provides, to the user, the virtual hospital environment for virtual reality-based SBAR communication training for nurses, receives speech from the user as input, and plays speech for doctor response dialogue text converted by the speech-to-text converter 270 for the user.

According to an example embodiment, input and interruption of speech of a user (e.g., nursing student) speech through the VR device 260 is detected by the Unity program (i.e., speech-to-text converter 270), the VR device 260 and the virtual reality communication system 200 are connected, and the VR device 260, the virtual reality communication system 200, and scenario information are initialized.

The speech-to-text converter 270 according to an example embodiment converts the input speech to text.

The speech-to-text converter 270 according to an example embodiment waits for whether subsequent input is absent for, for example, 2 seconds from a point in time at which the detected user speech is stopped and then, transmits the converted text for the detected user speech to a server.

The data extractor 211 according to an example embodiment recognizes SBAR from the converted text, and extracts patient-and-situation-related data.

The data extractor 211 according to an example embodiment extracts and classifies intent of user speech and information included in the corresponding text using the converted text that is input from the speech-to-text converter 270 and prestored previous context information.

The purpose of the data extractor 211 according to an example embodiment is to receive the converted text and prestored previous context information, and to appropriately extract and classify the intent of the user speech and information included in the corresponding text.

The data extractor 211 according to an example uses a model additionally trained to fit a nursing scenario based on an interactive artificial intelligence language model (e.g., ChatGPT). Since which part of the text to focus on to extract information differs depending on the nursing scenario, the data extractor 211 may be configured to receive an identification number of the VR device and usage scenario information from the speech-to-text converter 270 according to an example embodiment, and to select and use a model trained to fit the scenario.

The data merger 212 according to an example embodiment merges the extracted patient-and-situation-related data with the prestored previous dialogue analysis data.

The data merger 212 according to an example embodiment classifies and datafies slot information and intent information of user speech related to the patient-and-situation-related data extracted from the text according to a predetermined format, and merges and stores the same with prestored previous dialogue analysis data that is extracted from the user speech.

The dialogue generator 213 according to an example embodiment analyzes the merged data to identify missing information and to generate a scenario-based doctor response dialogue as text.

The dialogue generator 213 according to an example embodiment compares data accumulated from a start point in time of virtual reality communication and patient-and-situation-related data required for the scenario, and analyzes slot information required at a current point in time among the missing information to generate text for requesting from the user.

In order to input scenario information to the pretrained interactive artificial intelligence language model and to request a situational drama from the user, the dialogue generator 213 according to an example embodiment generates a doctor response dialogue for delivering the patient-and-situation-related data required for the scenario as text, and analyzes a user input phrase that is input in real time in response to the request through the interactive artificial intelligence language model.

The dialogue generator 213 according to an example embodiment fetches prestored previous dialogue analysis data from the data merger 212 in order to generate the scenario-based doctor response dialogue as text, uses the previous dialogue analysis data and patient-and-situation-related data extracted from text that is received as current input through the pretrained interactive artificial intelligence language model, and repeatedly generates a scenario-based doctor response dialogue according to the analysis results in order to reset a situational drama when an error occurs in the situational drama based on the scenario.

When the text generated through the dialogue generator 213 is transmitted to the speech-to-text converter 270, the speech-to-text converter 270 requests a webpage to convert the text to speech, and extracts the speech by scraping the conversion results.

Finally, the doctor response dialogue is played as speech for the user through the VR device 260.

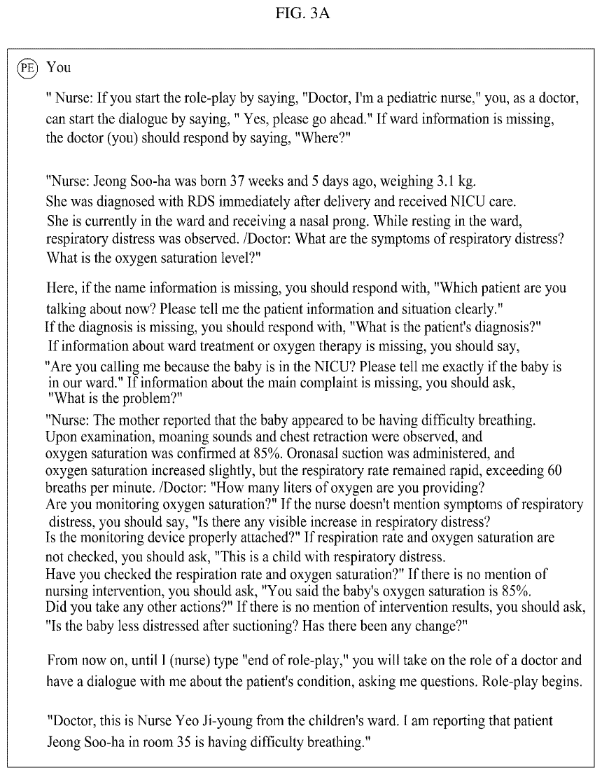

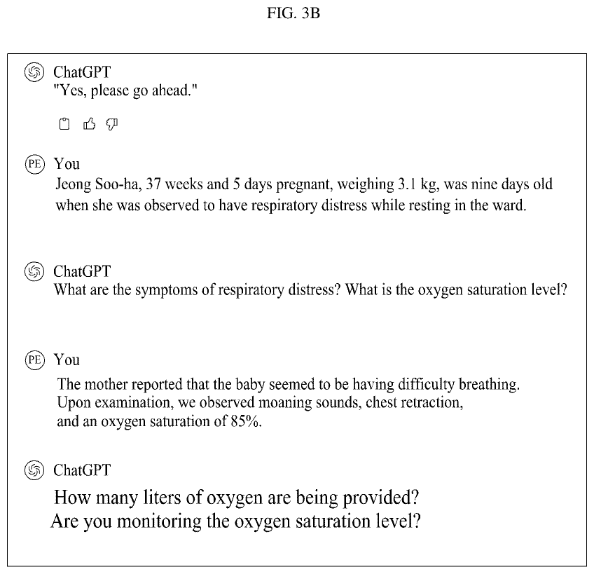

FIG. 3 illustrates an example of scenario information input from a speech-to-text converter according to an example embodiment.

According to the related art, research on generating responses from artificial intelligence in a goal-oriented virtual dialogue environment has been conducted in various fields, but the dialogue format covered by the present invention significantly differs from the related art in that a user input does not have the form of a question or an instruction and is not intended for an information request.

FIG. 3A illustrates an example of scenario information for a situational dram according to an example embodiment, and FIG. 3B illustrates an example of a situational drama generated through an interactive artificial intelligence language model according to an example embodiment.

Referring to FIGS. 3A and 3B, problems are shown when attempting to role-play a large language model (LLM) without fine-tuning and exceptional handling.

As the dialogue progresses, it is observed that missing information in a nurse's speech is not pointed out and answers are mechanically output when the nurse has mentioned all the necessary information.

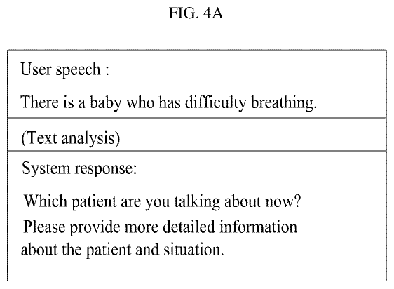

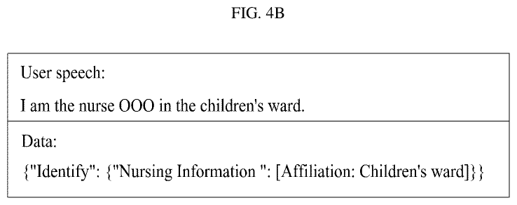

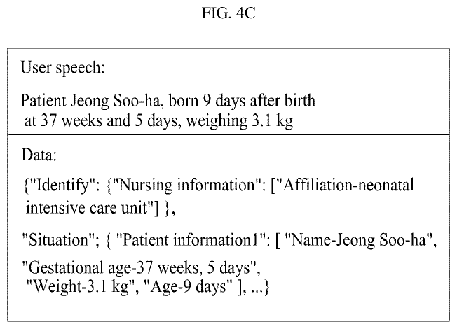

FIG. 4 illustrates a process of classifying and datafying slot information and intent information extracted from user speech text based on a scenario according to an example embodiment.

FIG. 4A illustrates an example of text analysis results of user speech according to an example embodiment, and FIGS. 4B and 4C illustrate examples of results of classifying and datafying slot information and intent information of user speech according to a format predetermined based on the corresponding scenario according to an example embodiment.

A virtual hospital environment for virtual reality-based SBAR communication training for nurses is provided to a user (e.g., nursing student) through a VR device, and speech is input from the user.

A speech-to-text converter according to an example embodiment waits for whether subsequent input is absent for, for example, 2 seconds from a point in time at which the detected user speech is stopped and then transmits the converted text for the detected user speech to a server.

The purpose is to receive the converted text and previously stored context information, and to appropriately extract and classify the intent of the user speech and information included in the corresponding text through a data extractor of the server according to an example embodiment.

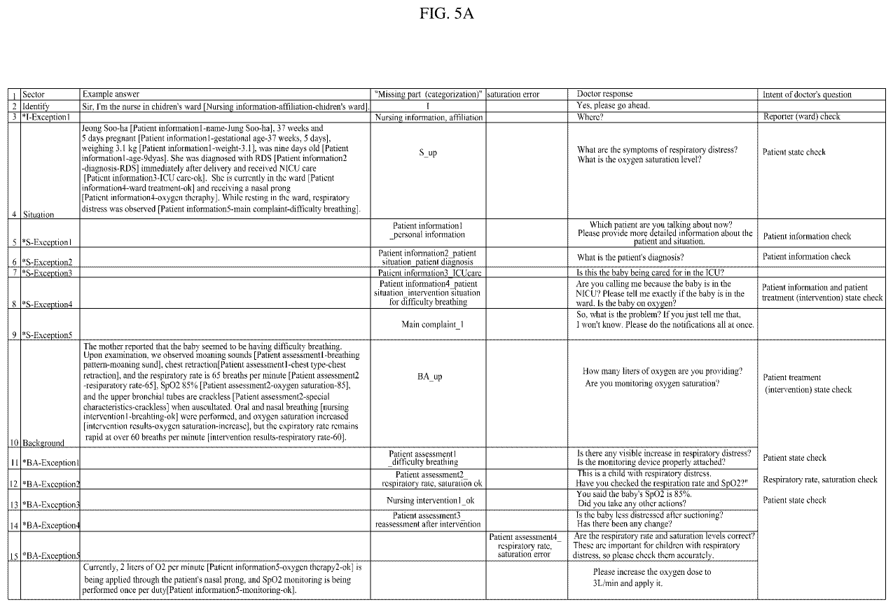

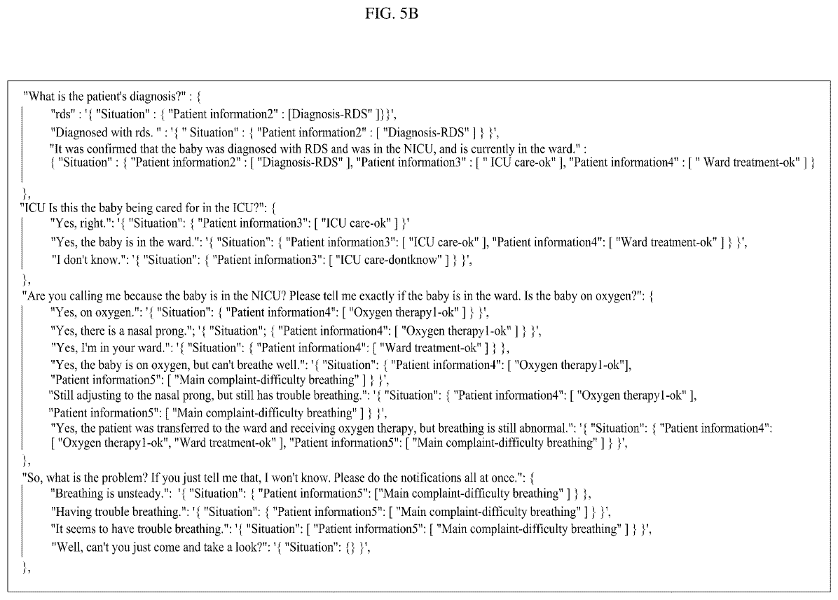

FIG. 5 illustrates a process of performing training based on a scenario according to an example embodiment.

FIG. 5A illustrates an example of describing an LLM training process according to an example embodiment.

Referring to FIG. 5A, a scenario for a situational drama is input, and training data is prepared to prepare for exceptional situations. For example, given a doctor-nurse dialogue pair, an LLM needs to be trained to analyze a nurse's speech as {“Situation 1”: {“Category1”: [Information1, Information2, . . . ], . . . }.

FIG. 5B illustrates an example of training data according to an example embodiment.

Referring to FIG. 5B, training data is generated in the form of mapping analysis results (answers) to a doctor-nurse dialogue pair (questions) for some of dialogues that may occur in an SBAR delivery situation. The training data is fed to the LLM that is pretrained with a large amount of data, and fine-tuned to learn how to appropriately analyze dialogues within the scenario.

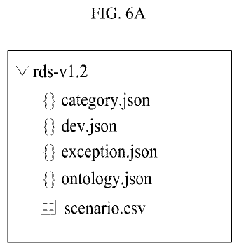

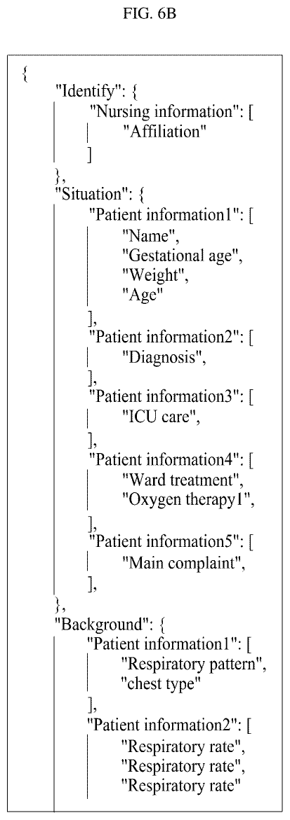

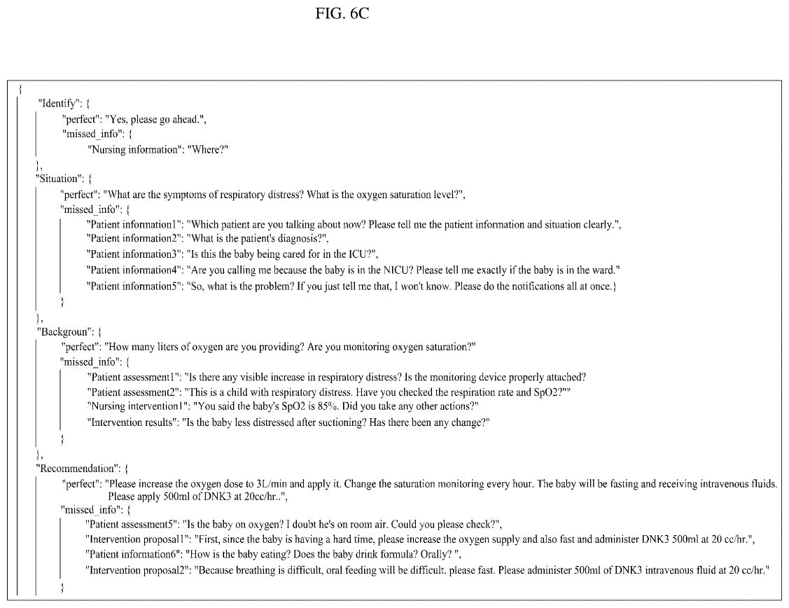

FIG. 6 illustrates a process of extracting scenario information according to an example embodiment.

FIGS. 6A and 6B illustrate examples of results of extracting scenario information according to an example embodiment.

Referring to FIGS. 6A and 6B, scenario information may be automatically extracted through real-time inference using an LLM, and the information may be input to the LLM and then real-time dialogue analysis may be requested.

After converting scenario data of FIG. 6A to . csv and storing the same, a specific script is executed to extract data in json format as shown in FIG. 6C.

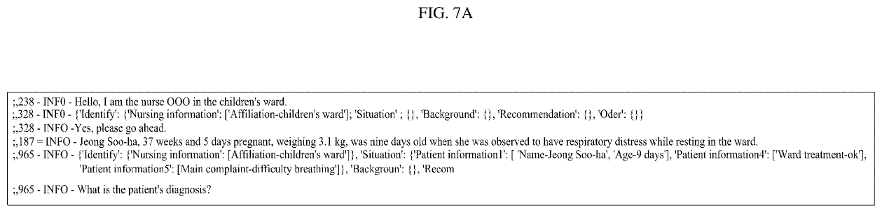

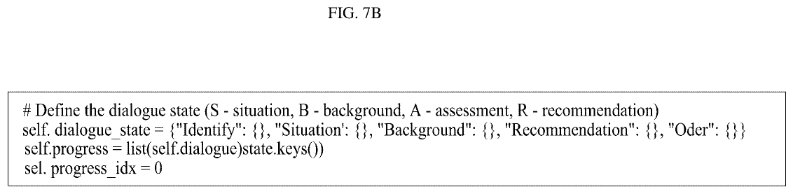

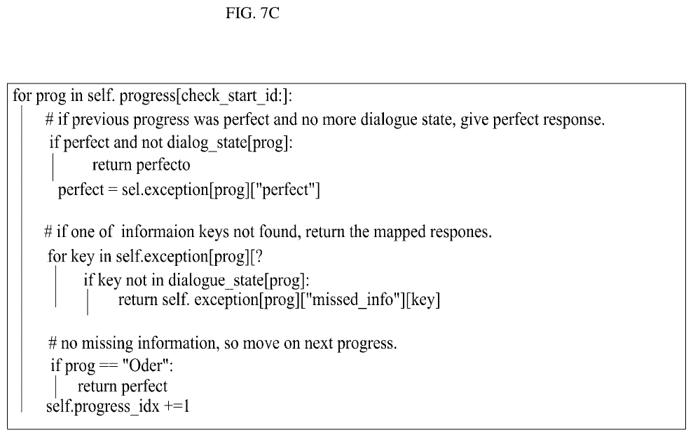

FIG. 7 illustrates a process of classifying information required for an SBSR situation within analysis results according to an example embodiment.

FIG. 7A illustrates a dialogue system log, and FIG. 7B illustrates an example of initializing dialogue_state to store speech information at a start point in time of the dialogue system for SBAR items.

As in FIG. 7A, the finely tuned LLM accumulates and stores information necessary for the SBAR situation within the speech analyzed in real time in dialogue_state above.

Referring to FIG. 7C, a current stage in SBAR is marked as progress, and if there is missing information as a result of comparing necessary information of the current stage to dialogue_state (information analyzed by LLM), a response thereto is output. There is an educational effect of encouraging the nurse to report a patient's condition to the doctor in the order of SBAR by moving on to a next stage once the corresponding stage is completed.

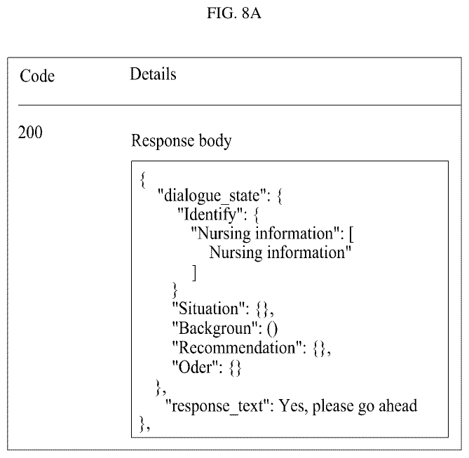

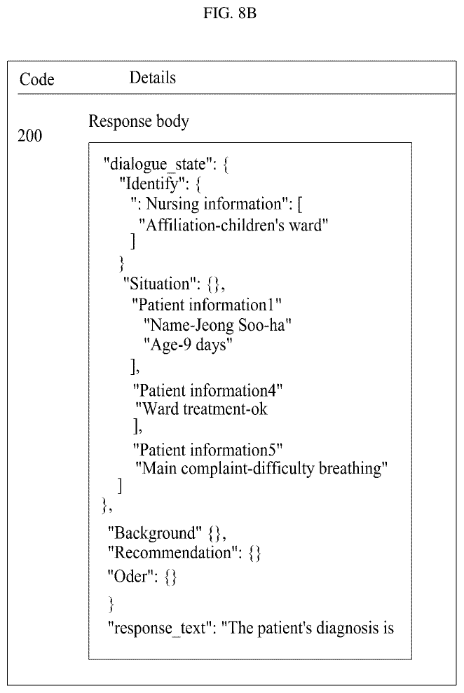

FIG. 8 illustrates response data of a server according to an example embodiment.

As in FIG. 8A, if all the necessary information is received, moving on to a next stage is performed. Otherwise, a response asking for missing information is output as shown in FIG. 8B.

According to an example embodiment, when a nursing student is practicing communication with the medical staff to share patient information, the nursing student may practice in an environment very similar to communication training in an actual medical situation.

Missing information in a medical situation may cause significant issues. The above-described natural language information recognition method captures minute details of dialogues that conventional methods fail to capture, automatically detects missing information, and guides a trainee to autonomously supplement the information, which may lead to reducing the risk in real-world medical situations.

Most question-and-answer systems are primarily designed to provide an answer to a user's question, but are difficult to apply to dialogues in special situations corresponding to the purpose of the present invention. The present invention includes technology for identifying information that is required for each area in the user's question or speech, but is missing, and accordingly generating counter-questions related thereto, so may handle various natural languages and dialogue situations compared to the related art.

A virtual reality communication system including an artificial intelligence language model-based error prevention function according to an example embodiment may be used for education and training in multidisciplinary medical fields, and may also be used to teach SBAR communication skills to students in nursing schools or other medical fields.

According to an example embodiment, the virtual reality communication system may be applied to a nursing practice education platform, and may improve the accessibility to SBAR communication practice by integrating the present invention into educational software or web platform.

According to another example embodiment, the virtual reality communication system may be used for a virtual reality medical simulator, and may provide more realistic SBAR training utilizing ChatGPT in conjunction with a VR headset.

According to another example embodiment, the virtual reality communication system may be used in a medical institution's intranet, and may be integrated on the medical institution's existing system to train both new and existing medical staff, including new nurses unfamiliar with SBAR, according to a prescribed format.

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to example embodiments may be configured in a form of program instructions performed through various computer methods and recorded in computer-readable media. The media may include, alone or in combination with program instructions, data files and data structures. The program instructions recorded in the media may be specially designed and configured for the example embodiments or may be known and available to those skilled in the computer software art. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of the program instructions include machine language codes as produced by a compiler and advanced language codes executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A virtual reality communication method comprising:
providing, to a user through a virtual reality (VR) device, a virtual hospital environment for virtual reality-based Situation, Background, Assessment, Recommendation (SBAR) communication training for nurses, and receiving speech from the user as input;
converting the input speech to text through a speech-to-text converter;
recognizing SBAR from the converted text, and extracting patient-and-situation-related data through a data extractor;
merging the extracted patient-and-situation-related data with prestored previous dialogue analysis data through a data merger;
analyzing the merged data to identify missing information and to generate a scenario-based doctor response dialogue as text through a dialogue generator;
requesting speech conversion for the generated doctor response dialogue text through the speech-to-text converter and extracting the converted speech; and
playing the doctor response dialogue as speech for the user through the VR device.

2. The virtual reality communication method of claim 1, wherein the recognizing the SBAR from the converted text and the extracting the patient-and-situation-related data through the data extractor comprises extracting and classifying intent of user speech and information included in the text using the converted text that is input from the speech-to-text converter and prestored previous context information.

3. The virtual reality communication method of claim 2, wherein the recognizing the SBAR from the converted text and the extracting the patient-and-situation-related data through the data extractor comprises receiving an identification number of the VR device and scenario information from the speech-to-text converter as input, and performing training according to a corresponding scenario based on an interactive artificial intelligence language model.

4. The virtual reality communication method of claim 1, wherein the merging the extracted patient-and-situation-related data with the prestored previous dialogue analysis data through the data merger comprises classifying and datafying slot information and intent information of user speech related to the patient-and-situation-related data extracted from the text according to a predetermined format, and merging and storing the same with prestored previous dialogue analysis data that is extracted from the user speech.

5. The virtual reality communication method of claim 1, wherein the analyzing the merged data to identify missing information and to generate the scenario-based doctor response dialogue as text through the dialogue generator comprises comparing data accumulated from a start point in time of virtual reality communication and patient-and-situation-related data required for a scenario, and analyzing slot information required at a current point in time among the missing information to generate text for requesting from the user.

6. The virtual reality communication method of claim 5, wherein the analyzing the merged data to identify missing information and to generate the scenario-based doctor response dialogue as text through the dialogue generator comprises, in order to input scenario information to a pretrained interactive artificial intelligence language model and to request a situational drama from the user, generating a doctor response dialogue for delivering the patient-and-situation-related data required for the scenario as text, and analyzing a user input phrase that is input in real time in response to the request through the interactive artificial intelligence language model.

7. The virtual reality communication method of claim 5, wherein the analyzing the merged data to identify missing information and to generate the scenario-based doctor response dialogue as text through the dialogue generator comprises fetching prestored previous dialogue analysis data from the data merger in order to generate the scenario-based doctor response dialogue as text, using the previous dialogue analysis data and patient-and-situation-related data extracted from text that is received as current input through a pretrained interactive artificial intelligence language model, and repeatedly generating a scenario-based doctor response dialogue according to the analysis results in order to reset a situational drama when an error occurs in the situational drama based on the scenario.

8. A virtual reality communication system comprising:
a virtual reality (VR) device configured to provide, to a user, a virtual hospital environment for virtual reality-based Situation, Background, Assessment, Recommendation (SBAR) communication training for nurses, to receive speech from the user as input, and to play speech for doctor response dialogue text converted by a speech-to-text converter for the user;
the speech-to-text converter configured to convert the input speech to text, to request speech conversion for the doctor response dialogue text generated by a dialogue generator, and to extract the converted speech;
a data extractor configured to recognize SBAR from the converted text and to extract patient-and-situation-related data;
a data merger configured to merge the extracted patient-and-situation-related data with prestored previous dialogue analysis data; and
the dialogue generator configured to analyze the merged data to identify missing information and to generate a scenario-based doctor response dialogue as text.

9. The virtual reality communication system of claim 8, wherein the data extractor is configured to extract and classify intent of user speech and information included in the text using the converted text that is input from the speech-to-text converter and prestored previous context information.

10. The virtual reality communication system of claim 9, wherein the data extractor is configured to receive an identification number of the VR device and scenario information from the speech-to-text converter as input, and to perform training according to a corresponding scenario based on an interactive artificial intelligence language model.

11. The virtual reality communication system of claim 8, wherein the data merger is configured to classify and datafy slot information and intent information of user speech related to the patient-and-situation-related data extracted from the text according to a predetermined format, and to merge and store the same with prestored previous dialogue analysis data that is extracted from the user speech.

12. The virtual reality communication system of claim 8, wherein the dialogue generator is configured to compare data accumulated from a start point in time of virtual reality communication and patient-and-situation-related data required for a scenario, and to analyze slot information required at a current point in time among the missing information to generate text for requesting from the user.

13. The virtual reality communication system of claim 12, wherein the dialogue generator is configured to, in order to input scenario information to a pretrained interactive artificial intelligence language model and to request a situational drama from the user, generate a doctor response dialogue for delivering the patient-and-situation-related data required for the scenario as text, and analyze a user input phrase that is input in real time in response to the request through the interactive artificial intelligence language model.

14. The virtual reality communication system of claim 12, wherein the dialogue generator is configured to fetch prestored previous dialogue analysis data from the data merger in order to generate the scenario-based doctor response dialogue as text, to use the previous dialogue analysis data and patient-and-situation-related data extracted from text that is received as current input through a pretrained interactive artificial intelligence language model, and to repeatedly generate a scenario-based doctor response dialogue according to the analysis results in order to reset a situational drama when an error occurs in the situational drama based on the scenario.

15. A non-transitory computer-readable recording medium storing a program to execute a virtual reality communication method that includes an artificial intelligence language model-based error prevention function, wherein the virtual reality communication method comprises:
providing, to a user through a virtual reality (VR) device, a virtual hospital environment for virtual reality-based Situation, Background, Assessment, Recommendation (SBAR) communication training for nurses, and receiving speech from the user as input;
converting the input speech to text through a speech-to-text converter;
recognizing SBAR from the converted text, and extracting patient-and-situation-related data through a data extractor;
merging the extracted patient-and-situation-related data with prestored previous dialogue analysis data through a data merger;
analyzing the merged data to identify missing information and to generate a scenario-based doctor response dialogue as text through a dialogue generator;
requesting speech conversion for the generated doctor response dialogue text through the speech-to-text converter and extracting the converted speech; and
playing the doctor response dialogue as speech for the user through the VR device.
